(19) United States
(12) Patent Application Publication
(10) Pub. No.: US 2014/0250944 A1
(43) Pub. Date: Sep. 11, 2014

(54) Energy Recovery Apparatus for a Refrigeration System

(71) Applicant: Regal Beloit America, Inc., Beloit, WI (US)

(72) Inventors: Steven W. Post, Cassville, MO (US); Bobby D. Garrison, Cassville, MO (US)

(21) Appl. No.: 13/948,942

(22) Filed: Jul. 23, 2013

Related U.S. Application Data
(63) Continuation-in-part of application No. 13/788,600, filed on Mar. 7, 2013.

(51) Int. Cl. F25B 41/00; B23P 15/26

(52) U.S. Cl. CPC F25B 41/00; B23P 15/26
USPC 62/498; 29/890.031; 60/643

(57) ABSTRACT

An energy recovery apparatus for use in a refrigeration system, comprises an intake port, a nozzle, a turbine and a discharge port. The intake port is adapted to be in fluid communication with a condenser of a refrigeration system. The nozzle comprises a fluid passageway. The nozzle is configured to expand refrigerant discharged from the condenser and increase velocity of the refrigerant as it passes through the fluid passageway. The turbine is positioned relative to the nozzle and configured to be driven by refrigerant discharged from the fluid passageway. The discharge port is downstream of the turbine and is configured to be in fluid communication with an evaporator of the refrigeration system.

This patent application is a continuation in part of U.S. patent application Ser. No. 13/788,600, filed Mar. 7, 2013, which is incorporated herein by reference.

### BACKGROUND OF THE INVENTION

1. Field of the Invention

The present invention pertains to a refrigeration system and more specifically to the expansion valve of the refrigeration system that controls the expansion of the refrigerant between the condenser and the evaporator coils of the system.

2. Description of the Related Art

In a conventional refrigeration system, a liquid refrigerant is circulated through the system and absorbs and removes heat from an internal environment that is cooled by the system and then rejects that absorbed heat in a separate external environment.

FIG. 1 is a temperature (T) versus entropy (S) diagram of a conventional refrigeration cycle. In the conventional refrigeration cycle, refrigerant vapor enters the compressor at point 1 and is compressed to an elevated pressure at point 2. The refrigerant then travels through the condenser coil nearly at constant pressure from point 2 to point 3. At point 3, the elevated pressure of the refrigerant has a saturation temperature that is well above the ambient temperature of the external environment. As the refrigerant passes through the condenser coil the refrigerant vapor is condensed into a liquid. From point 3 to point 4 the liquid refrigerant is cooled further by about 10 degrees F. below the saturation temperature. After the condenser, from point 4 to point 5, the liquid refrigerant passes through an expansion valve and the liquid refrigerant is lowered in pressure to a liquid-vapor state, with the majority of the refrigerant being liquid. The expansion valve in the conventional refrigeration cycle is essentially an orifice. The decrease in pressure of the refrigerant is a constant enthalpy process. Entropy increases due to the mixing friction that occurs in the standard expansion valve. The cold refrigerant then passes through the evaporator coils from point 5 to point 1. A fan circulates the warm air of the internal environment across the evaporator coils and the coils gather the heat from the circulated air of the internal environment. The refrigerant vapor then returns to the compressor at point 1 to complete the refrigeration cycle.

FIG. 2 is a schematic representation of a standard refrigeration system. The standard system shown in FIG. 2 has four basic components: a compressor 6, a condenser 7, an expansion valve (also called a throttle valve) 8, and an evaporator 9. The system also typically includes an external fan 10 and an internal fan 11.

In the operation of the refrigeration system, the circulating refrigerant enters the compressor 6 as a vapor and is compressed to a high pressure, resulting in a higher temperature of the refrigerant. The hot, compressed vapor is then in the thermodynamic state known as a super-heated vapor. At this temperature and pressure, the refrigerant can be condensed with typically available ambient cooling air from the external environment of the refrigeration system.

The hot vapor is passed through the condenser where it is cooled in the condenser coils and condenses into a liquid. The external fan 10 moves the ambient air of the external environment across the condenser coils. The heat of the refrigerant passing through the condenser coils passes from the coils to the air circulated through the coils by the fan 10. As the heat of the refrigerant passes from the condenser coils into the circulating air, the refrigerant condenses to a liquid.

The liquid refrigerant then passes through the expansion valve 8 where the liquid undergoes an abrupt reduction in pressure which causes part of the liquid refrigerant to evaporate to a vapor. The evaporation lowers the temperature of the liquid and vapor refrigerant to a temperature that is colder than the temperature of the internal environment of the refrigeration system that is being cooled.

The cold liquid and vapor refrigerant are then routed through the evaporator coils. The internal fan 11 circulates the warm air of the internal environment across the coils of the evaporator 9. The warm air of the internal environment circulated by the fan 11 through the coils of the evaporator 9 evaporates the liquid part of the cold refrigerant mixture passing through the coils of the evaporator 9. Simultaneously, the circulating air passed through the coils of the evaporator 9 is cooled and lowers the temperature of the internal environment.

The refrigerant vapor exiting the coils of the evaporator 9 is routed back to the compressor 6 to complete the refrigeration cycle.

Air conditioning designers have for years increased the efficiency of the standard refrigeration cycle described above by several means. Some examples of those that have been successful include:
Use of “scroll” compressors that are more efficient than screw or piston-type compressors.
Use of high efficiency compressor motors such as electrically commutated permanent magnet motors.
Use of oversize condenser coils that lower the condenser pressure required.
Use of oversize evaporator coils that raise the evaporator pressure required.
Use of modulating systems that run part of the time at reduced load to increase overall cycle efficiency.
Use of high efficiency blower housings and blower motors to reduce the non-compressor electrical usage.

However, even with these substantial improvements, obtaining a higher seasonal energy efficiency ratio (SEER) ratings are desired together with less expensive refrigeration systems that do not involve expensive oversize copper and aluminum heat exchangers.

One area where there have been attempts in improving the efficiency in sub-critical point refrigeration cycles is in harnessing the expansion energy that is normally lost across the expansion valve. A theoretical sub-critical point refrigeration cycle that would accomplish this would have a TS diagram such as that shown in FIG. 3.

A theoretical refrigeration system that would produce a TS diagram such as that shown in FIG. 3 is shown schematically in FIG. 4.

The refrigeration cycle shown in FIG. 4 is substantially the same as the standard refrigeration cycle discussed earlier and shown in FIG. 2, except that in the refrigeration cycle of FIG. 4, the uncontrolled expansion of the refrigerant that occurs at the expansion valve is instead a controlled expansion with the resultant expansion event being closer to an isentropic event instead of an adiabatic event. The end result of the refrigeration cycle shown in FIG. 4 is that work can be removed from the controlled expansion, and additional refrigeration capacity can be used which is equal to the energy that was removed.

There have been attempts to duplicate the refrigeration cycle shown in FIG. 4 in the past, but for different reasons they were not successful.

U.S. Pat. No. 3,934,424 discloses an attempt at duplicating the refrigeration cycle shown in FIG. 4. However, the requirement of a second compressor that was mechanically coupled to the expansion valve added complexity to the attempt.

U.S. Pat. No. 5,819,554 also discloses an attempt at duplicating the refrigeration cycle of FIG. 4. However, requiring the expansion valve to be directly coupled to the compressor also increased the complexity of this attempt. In addition, putting the cold expansion refrigerant lines out at the compressor could potentially negatively affect the commercialization of the system.

U.S. Pat. No. 6,272,871 also discloses another attempt at duplicating the refrigeration cycle of FIG. 4 through the use of a positive displacement expansion valve. However, this also required a throttle valve being positioned before the expansion device so that the refrigerant moving through the device had a higher vapor content.

U.S. Pat. No. 6,543,238 also discloses an attempt to duplicate the refrigeration cycle of FIG. 4 by using a supercritical point vapor compression refrigerant cycle. This attempt employed a scroll expander, similar to a scroll compressor to expand the supercritical refrigerant. Being a supercritical point cycle, the refrigerant is never incompressible, and therefore easier to manage through the energy recovery system. This system appears to be too complex and too expensive for a residential application.

### SUMMARY OF THE INVENTION

One aspect of the present invention is a refrigeration system comprising an evaporator, a compressor, a condenser, and an energy recovery apparatus. The evaporator comprises an intake port and a discharge port. The evaporator is configured to evaporate a cold refrigerant from a liquid-vapor state to a vapor state. The compressor comprises an intake port and a discharge port. The intake port of the compressor is in fluid communication with the discharge port of the evaporator. The compressor is configured to receive refrigerant discharged from the evaporator and compress the refrigerant to an elevated, sub-critical pressure. The condenser comprises an intake port and a discharge port. The intake port of the condenser is in fluid communication with the discharge port of the compressor. The condenser is configured to receive refrigerant discharged from the compressor and condense the refrigerant discharged from the compressor to one of a saturated-liquid state, a liquid state cooler than the saturated-liquid state, and a liquid-vapor state near the saturated-liquid state. The energy recovery apparatus comprises an intake port and a discharge port. The intake port of the energy recovery apparatus is in fluid communication with the discharge port of the condenser. The discharge port of the energy recovery apparatus is in fluid communication with the intake port of the evaporator. The energy recovery apparatus further comprises a nozzle, a turbine, and a generator. The nozzle comprises a necked-down region and a tube portion. The tube portion is downstream of the necked-down region. The necked-down region has a downstream end with a cross-sectional area less than a cross-sectional area of the intake port of the energy recovery apparatus. The nozzle is configured to expand refrigerant discharged from the condenser and increase velocity of the refrigerant as it passes through the nozzle. The turbine is positioned and configured to be driven by refrigerant discharged from the nozzle. The discharge port of the energy recovery apparatus is downstream of the turbine. The generator is coupled to the turbine and driven by the turbine. The generator is configured to produce electricity as a result of the turbine being driven by refrigerant discharged from the nozzle. The nozzle is adapted and configured such that refrigerant entering the nozzle at X % liquid and (100-X) % vapor, by mass, is expanded as it passes through the nozzle and is discharged from the nozzle in a liquid-vapor state that is at most at (X-5) % liquid and at least (105-X) % vapor, by mass. The nozzle is also adapted and configured such that the liquid refrigerant discharged from the nozzle has a velocity that is at least 60% of the velocity of the vapor refrigerant discharged from the nozzle. Another aspect of the present invention is a method of operating such a refrigeration system in a manner that refrigerant enters the nozzle in a liquid state and is discharged from the nozzle in a liquid-vapor state.

Another aspect of the present invention is an energy recovery apparatus for use in a refrigeration system, in which the refrigeration system comprises an evaporator, a compressor and a condenser. The evaporator is configured to evaporate a cold refrigerant from a liquid-vapor state to a vapor state. The compressor is configured to receive refrigerant discharged from the evaporator and compress the refrigerant to an elevated, sub-critical pressure. The condenser is configured to receive refrigerant discharged from the compressor and condense the refrigerant to one of a saturated-liquid state, a liquid state cooler than the saturated-liquid state, and a liquid-vapor state near the saturated-liquid state. The energy recovery apparatus comprises an intake port adapted to be in fluid communication with the condenser, a discharge port adapted to be in fluid communication with the evaporator, a nozzle, a turbine, and a generator. The nozzle comprises a necked-down region and a tube portion. The tube portion is downstream of the necked-down region. The nozzle is configured to expand refrigerant discharged from the condenser and increase velocity of the refrigerant as it passes through the nozzle. The turbine is positioned and configured to be driven by refrigerant discharged from the nozzle. The discharge port of the energy recovery apparatus is downstream of the turbine. The generator is coupled to the turbine and driven by the turbine. The generator is configured to produce electricity as a result of the turbine being driven by refrigerant discharged from the nozzle. The nozzle is adapted and configured such that refrigerant entering the nozzle at X % liquid and (100-X) % vapor, by mass, is expanded as it passes through the nozzle and is discharged from the nozzle in a liquid-vapor state that is at most at (X-10) % liquid and at least (110-X) % vapor, by mass. The nozzle is also adapted and configured such that the liquid refrigerant discharged from the nozzle has a velocity that is at least 60% of the velocity of the vapor refrigerant discharged from the nozzle.

Another aspect of the present invention is a method comprising selling an energy recovery apparatus. The energy recovery apparatus comprises an intake port adapted to be in fluid communication with the condenser, a discharge port adapted to be in fluid communication with the evaporator, a nozzle, and a turbine. The nozzle comprises a necked-down region and a tube portion. The tube portion is downstream of the necked-down region. The necked-down region has a downstream end having a cross-sectional area less than a cross-sectional area of the intake port of the energy recovery apparatus. The nozzle is configured to expand refrigerant discharged from the condenser and increase velocity of the refrigerant as it passes through the nozzle. The turbine is positioned and configured to be driven by refrigerant discharged from the nozzle. The discharge port of the energy recovery apparatus is downstream of the turbine. The nozzle is adapted and configured such that refrigerant entering the nozzle at X % liquid and (100-X) % vapor, by mass, is expanded as it passes through the nozzle and is discharged from the nozzle in a liquid-vapor state that is at most at (X-5) % liquid and at least (105-X) % vapor, by mass. The nozzle is also adapted and configured such that the liquid refrigerant discharged from the nozzle has a velocity that is at least 60% of the velocity of the vapor refrigerant discharged from the nozzle. The energy recovery apparatus further comprises a generator coupled to the turbine and driven by the turbine. The generator is configured to produce electricity as a result of the turbine being driven by refrigerant discharged from the nozzle. The energy recovery apparatus further comprises a housing encompassing the turbine and the generator. The method further comprises including with the energy recovery apparatus indicia (e.g., instructions, explanation, etc.) that the energy recovery apparatus is to be placed in fluid communication with an evaporator of a refrigeration system.

Another aspect of the present invention is a method comprising modifying a refrigeration system. The refrigeration system comprises an evaporator, a compressor, a condenser and an expansion valve. The evaporator comprises an intake port and a discharge port. The evaporator is configured to evaporate a cold refrigerant from a liquid-vapor state to a vapor state. The compressor comprises an intake port and a discharge port. The intake port of the compressor is in fluid communication with the discharge port of the evaporator. The compressor is configured to receive refrigerant discharged from the evaporator and compress the refrigerant to an elevated, sub-critical pressure. The condenser comprises an intake port and a discharge port. The intake port of the condenser is in fluid communication with the discharge port of the compressor. The condenser is configured to receive refrigerant discharged from the compressor and condense the refrigerant discharged from the compressor to one of a saturated-liquid state, a liquid state cooler than the saturated-liquid state, and a liquid-vapor state near the saturated-liquid state. The expansion valve comprises an intake port and a discharge port. The intake port of the expansion valve is in fluid communication with the discharge port of the condenser. The discharge port of the expansion valve is in fluid communication with intake port of the evaporator. The method comprising replacing the expansion valve with an energy recovery apparatus. The energy recovery apparatus comprises an intake port adapted to be in fluid communication with the condenser, a discharge port adapted to be in fluid communication with the evaporator, a nozzle, and a turbine. The nozzle comprises a necked-down region and a tube portion. The tube portion is downstream of the necked-down region. The necked-down region has a downstream end having cross-sectional area less than a cross-sectional area of the intake port of the energy recovery apparatus. The nozzle is configured to expand refrigerant discharged from the condenser and increase velocity of the refrigerant as it passes through the nozzle. The turbine is positioned and configured to be driven by refrigerant discharged from the nozzle. The discharge port of the energy recovery apparatus is downstream of the turbine. The nozzle is adapted and configured such that refrigerant entering the nozzle at X % liquid and (100-X) % vapor, by mass, is expanded as it passes through the nozzle and is discharged from the nozzle in a liquid-vapor state that is at most at (X-5) % liquid and at least (105-X) % vapor, by mass. The nozzle is also adapted and configured such that the liquid refrigerant discharged from the nozzle has a velocity that is at least 60% of the velocity of the vapor refrigerant discharged from the nozzle.

Another aspect of the present invention is an energy recovery apparatus for use in a refrigeration system. The refrigeration system comprises an evaporator, a compressor and a condenser. The evaporator is configured to evaporate a cold refrigerant from a liquid-vapor state to a vapor state. The compressor is configured to receive refrigerant discharged from the evaporator and compress the refrigerant to an elevated, sub-critical pressure. The condenser is configured to receive refrigerant discharged from the compressor and condense the refrigerant to one of a saturated-liquid state, a liquid state cooler than the saturated-liquid state, and a liquid-vapor state near the saturated-liquid state. The energy recovery apparatus comprises an intake port, a discharge port, a nozzle, a turbine, a generator, and a housing. The intake port is adapted to be in fluid communication with the condenser. The discharge port is adapted to be in fluid communication with the evaporator. The nozzle is adapted and configured to expand refrigerant discharged from the condenser and increase velocity of the refrigerant as it passes through the nozzle. The turbine is positioned and configured to be driven by refrigerant discharged from the nozzle. The discharge port of the energy recovery apparatus is downstream of the turbine. The generator is coupled to the turbine and driven by the turbine. The generator is configured to produce electricity as a result of the turbine being driven by refrigerant discharged from the nozzle. The housing encompasses the turbine and the generator.

Another aspect of the present invention is an energy recovery apparatus for use in a refrigeration system. The refrigeration system comprises an evaporator, a compressor, and a condenser. The refrigeration system is configured to circulate refrigerant along a flow path such that the refrigerant flows from the evaporator to the compressor, and from the compressor to the condenser, and from the condenser to the evaporator. The energy recovery apparatus is adapted and configured to be in the flow path operatively between the condenser and the evaporator. The energy recovery apparatus comprises an intake port, a discharge port, a nozzle, a turbine and a housing. The intake port is adapted to receive refrigerant and permit the refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The downstream cross-section of the passageway is closer to the discharge end of the passageway than to the upstream cross-section. The cross-sectional area of the passageway at the downstream cross-section is not greater than the cross-sectional area of the passageway at any point along the passageway length. The passageway at the downstream cross-section has an effective diameter. The effective diameter is defined as (4A/π)^{1/2}, where A is the cross-sectional area of the passageway at the downstream cross-section. The passageway length is at least five times the effective diameter. The nozzle is adapted and configured such that refrigerant entering the nozzle at X % liquid and (100-X) % vapor, by mass, is expanded as it passes through the nozzle and is discharged from the discharge end of the passageway in a liquid-vapor state with a liquid component and a vapor component. The turbine is positioned and configured to be driven by refrigerant discharged from the discharge end of the passageway. The discharge port of the energy recovery apparatus is downstream of the turbine. The turbine is within the housing.

Another aspect of the present invention is an energy recovery apparatus for use in a refrigeration system. The refrigeration system comprises an evaporator, a compressor, and a condenser. The refrigeration system is configured to circulate refrigerant along a flow path such that the refrigerant flows from the evaporator to the compressor, and from the compressor to the condenser, and from the condenser to the evaporator. The energy recovery apparatus is adapted and configured to be in the flow path operatively between the condenser and the evaporator. The energy recovery apparatus comprises an intake port, a discharge port, a nozzle, a turbine, and a housing. The intake port is adapted to receive refrigerant and permit the refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The discharge end of the passageway is adjacent the downstream cross-section of the passageway. The cross-sectional area of the passageway at the downstream cross-section is not greater than the cross-sectional area of the passageway at any point along the passageway length. The nozzle is adapted and configured such that refrigerant entering the nozzle at X % liquid and (100-X) % vapor, by mass, is expanded as it passes through the nozzle and is discharged from the discharge end of the passageway in a liquid-vapor state with a liquid component and a vapor component. The nozzle is adapted and configured to discharge the liquid component of the refrigerant from the discharge end of the passageway at a velocity of at least about 190 feet per second (58 m/s). The turbine is positioned and configured to be driven by refrigerant discharged from the discharge end of the passageway. The discharge port of the energy recovery apparatus is downstream of the turbine. The turbine is within the housing.

Another aspect of the present invention is an energy recovery apparatus for use in a refrigeration system. The refrigeration system comprises an evaporator, a compressor, and a condenser. The refrigeration system is configured to circulate refrigerant along a flow path such that the refrigerant flows from the evaporator to the compressor, and from the compressor to the condenser, and from the condenser to the evaporator. The energy recovery apparatus is adapted and configured to be in the flow path operatively between the condenser and the evaporator. The energy recovery apparatus comprises an intake port, a discharge port, a nozzle, and a turbine. The intake port is adapted to receive refrigerant and permit the refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The discharge end of the passageway is adjacent the downstream cross-section of the passageway. The cross-sectional area of the passageway at the downstream cross-section is not greater than the cross-sectional area of the passageway at any point along the passageway length. The nozzle is adapted and configured such that refrigerant entering the nozzle at X % liquid and (100-X) % vapor, by mass, is expanded as it passes through the nozzle and is discharged from the discharge end of the passageway in a liquid-vapor state with a liquid component and a vapor component. The nozzle is adapted and configured such that the liquid component of the refrigerant discharged from the discharge end of the passageway has a velocity that is at least 60% that of the vapor component of the refrigerant discharged from the discharge end of the passageway. The turbine is positioned and configured to be driven by refrigerant discharged from the discharge end of the passageway. The discharge port of the energy recovery apparatus is downstream of the turbine.

### BRIEF DESCRIPTION OF THE DRAWINGS

FIG. 1 is a temperature (T) versus entropy (S) diagram of a conventional refrigeration cycle.

FIG. 2 is schematic representation of a standard refrigeration system.

FIG. 3 is a temperature (T) versus entropy (S) diagram of a sub-critical refrigeration cycle.

FIG. 4 is a schematic representation of a refrigeration system that would produce the TS diagram of FIG. 3.

FIG. 5 is a perspective view of an embodiment of an energy recovery apparatus of the present invention.

FIG. 6 is a top plan view of the energy recovery apparatus of FIG. 5.

FIG. 7 is a cross-sectional view taken along the plane of line 7-7 of FIG. 6.

FIG. 8 is a side-elevational view of the energy recovery apparatus of FIG. 5.

FIG. 9 is a cross-sectional view taken along the plane of line 9-9 of FIG. 8.

FIG. 10 is a cross-section view of another embodiment of an energy recovery apparatus of the present invention, similar to FIG. 9, but having a converging tube portion.

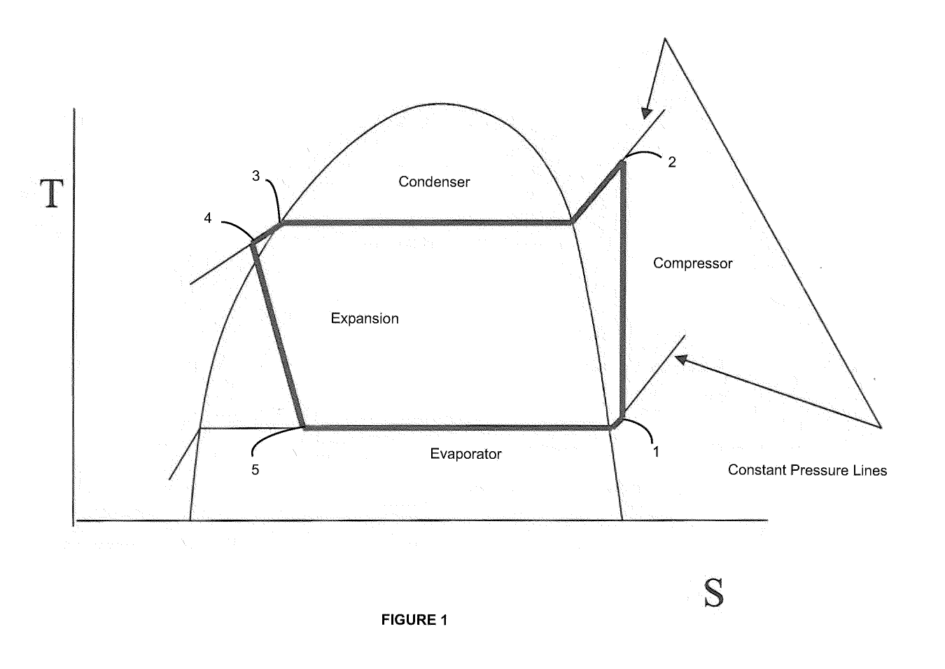

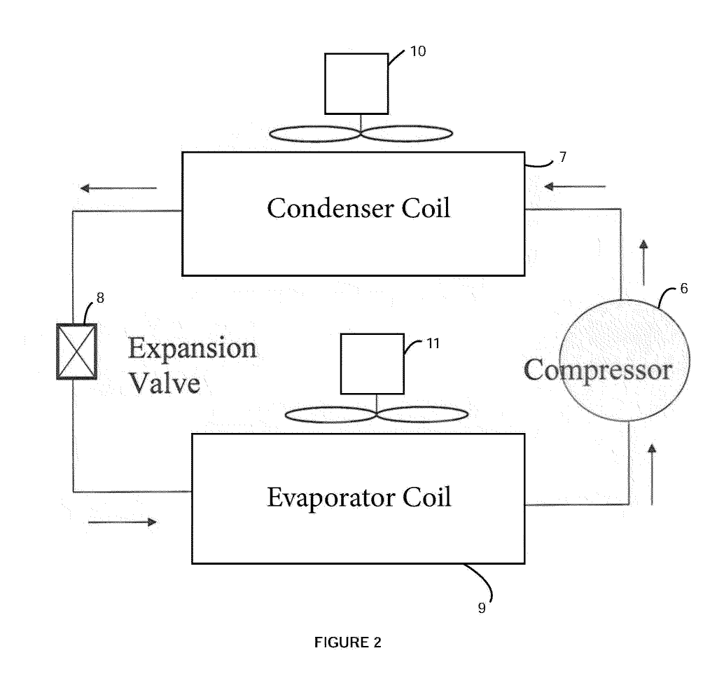

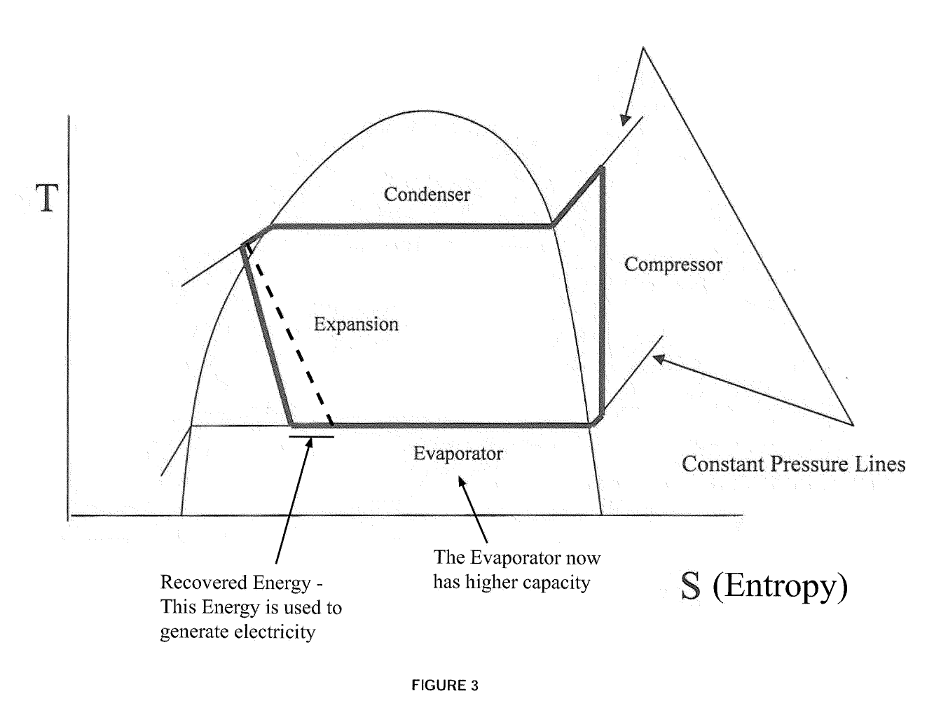

### DETAILED DESCRIPTION OF THE PREFERRED EMBODIMENTS OF THE INVENTION

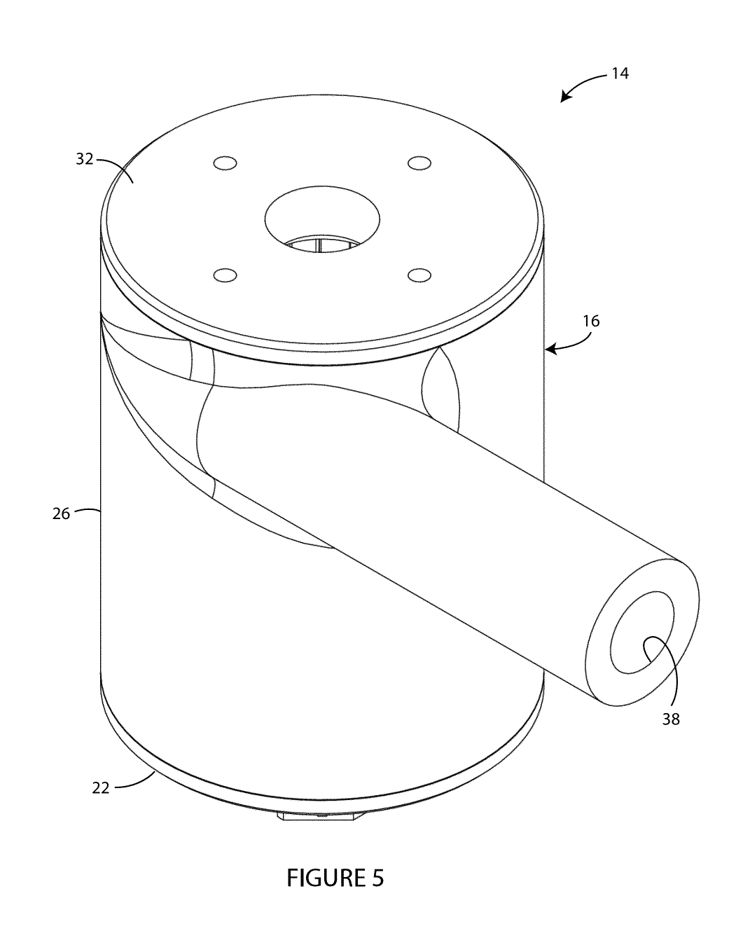

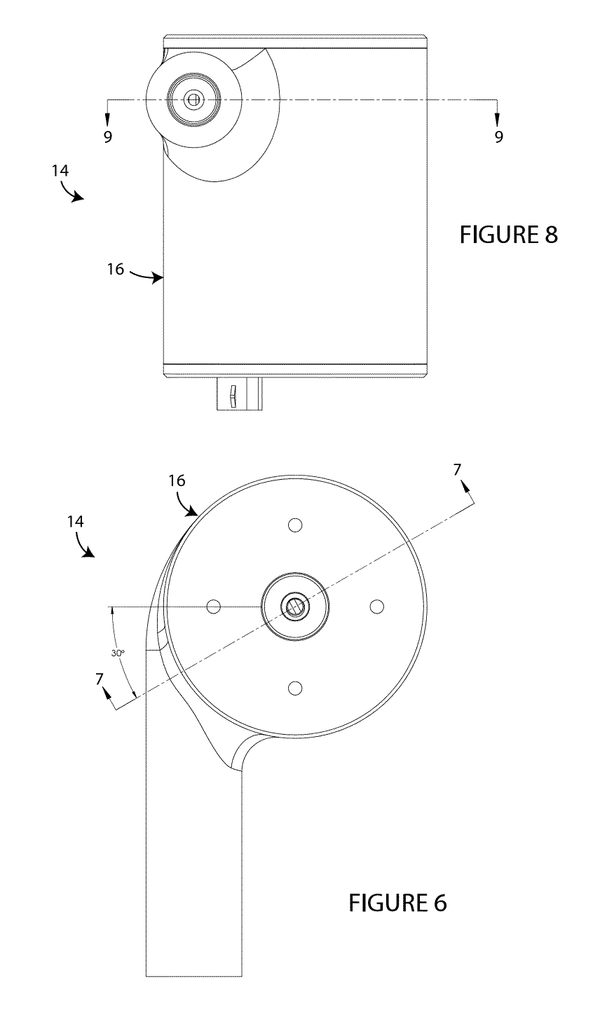

An embodiment of an energy recovery apparatus of the present invention is indicated generally by reference numeral 14 in FIGS. 5-9. The energy recovery apparatus 14 is basically comprised of a housing 16, a turbine 18 and a generator 20. The turbine 18 and generator 20 are preferably contained in the housing.

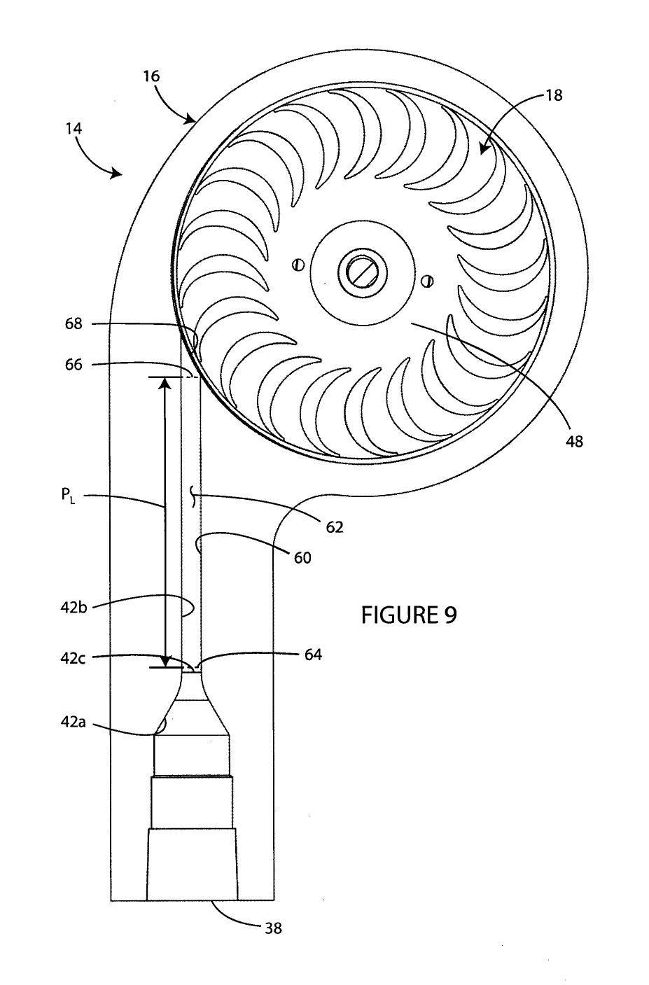

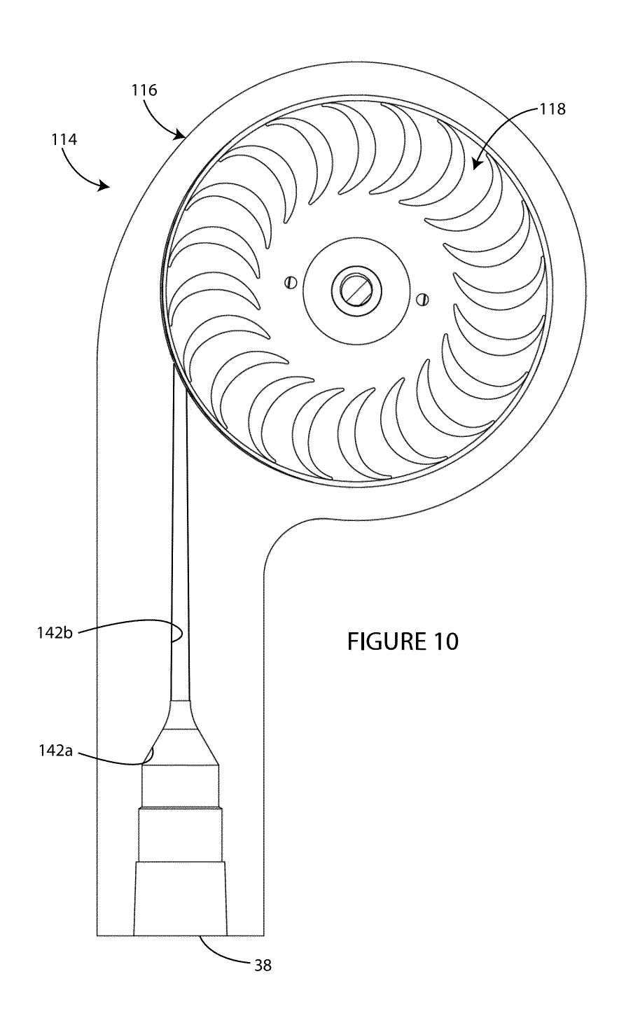

The housing 16 is preferably comprised of three parts. A first, lower center housing part 22 has an interior that supports a bearing assembly 24. The center part 22 is attached to a second, side wall part 26 of the housing. The side wall 26 is preferably generally cylindrical in shape and extends around an interior volume of the housing 16. The center housing part 22 also includes a hollow center column 28. The interior of the center column 28 supports a second bearing assembly 30. A third, cover part of the housing 32 is attached to the top of the side wall 26. The cover part 32 encloses the hollow interior of the housing 16. The center housing part 22 preferably has an outlet opening (or discharge port) 34 that is the outlet for the refrigerant passing through the expansion energy recovery apparatus 14. The discharge port 34 of the energy recovery apparatus 14 is downstream of the turbine 18. The housing side wall 26 is preferably formed with a refrigerant inlet opening 38. This is the inlet for the refrigerant entering the expansion energy recovery apparatus 14. Referring to FIG. 9, the housing side wall 26 includes a nozzle 40 inside the inlet opening 38. Preferably, the nozzle 40 is integrally formed with the side wall 26 as a single, unitary, monolithic piece. The nozzle 40 preferably includes a necked-down region 42a and a tube portion 42b. The necked-down region 42a is downstream of the inlet opening 38, and the tube portion 42b is downstream of the necked-down region. The necked-down region 42a has a downstream end 42c. The downstream end 42c of the necked-down region 42a has a cross-sectional area less than a cross-sectional area of the intake opening 38 of the energy recovery apparatus. Preferably, the necked-down region 42a gradually decreases in cross-sectional area toward its downstream end 42c. Alternatively, the necked-down region may abruptly decrease in cross-sectional area without departing from the scope of the present invention. The tube portion 42b has an inlet end and a downstream (or discharge) end that opens into the interior of the housing 16 and in particular adjacent the turbine 18. The tube portion 42b is preferably in the form of a cylindrical bore, but can be of other shapes without departing from the scope of this invention. The necked-down region 42a may be integral with the tube portion 42b or the necked-down region may be a separate piece joined to the tube portion. In the present embodiment, at least a portion of the tube portion 42b comprises a conduit region 60. The conduit region 60 defines a passageway 62. The passageway 62 is downstream of the necked down region 42a. The necked-down region 42a and the passageway 62 are adapted to constitute portions of a flow path of a refrigeration system. In other words, when the energy recovery apparatus 14 is in the refrigeration system and the refrigeration system is operating to circulate refrigerant, the necked-down region 42a is a portion of the refrigerant flow path and the passageway is a portion of the refrigerant flow path. The passageway 62 has an upstream cross-section, indicated by the dash line 64, a downstream cross-section, indicated by the dash line 66, a passageway length P_{L} extending from the upstream cross-section to the downstream cross-section, and a discharge end 68. The downstream cross-section 66 is closer to the discharge end 68 of the passageway than to the upstream cross section 64. In the present embodiment, the downstream cross-section 66 of the passageway 62 is adjacent the downstream end 68 of the passageway. The cross-sectional area of the passageway 62 at the downstream cross-section 66 is not greater than the cross-sectional area of the passageway at any point along the passageway length P_{L}. The passageway 62 at the downstream cross-section 66 has an effective diameter. The effective diameter is defined as (4A/π)^{1/2}, where A is the cross-sectional area of the passageway at the downstream cross-section 66. As used herein, the cross-sectional area is the planar area generally perpendicular to the intended direction of flow at the given point in the passageway, e.g., at the downstream cross-section 66. The cross section of the passageway at any point along the passageway length P_{L} is preferably circular, but it is to be understood that other cross-sectional shapes may be employed without departing from this invention. The passageway length P_{L} is preferably at least five times the effective diameter, and more preferably at least seven and one-half times the effective diameter, and even more preferably at least ten times the effective diameter, and still more preferably at least twelve times the effective diameter.

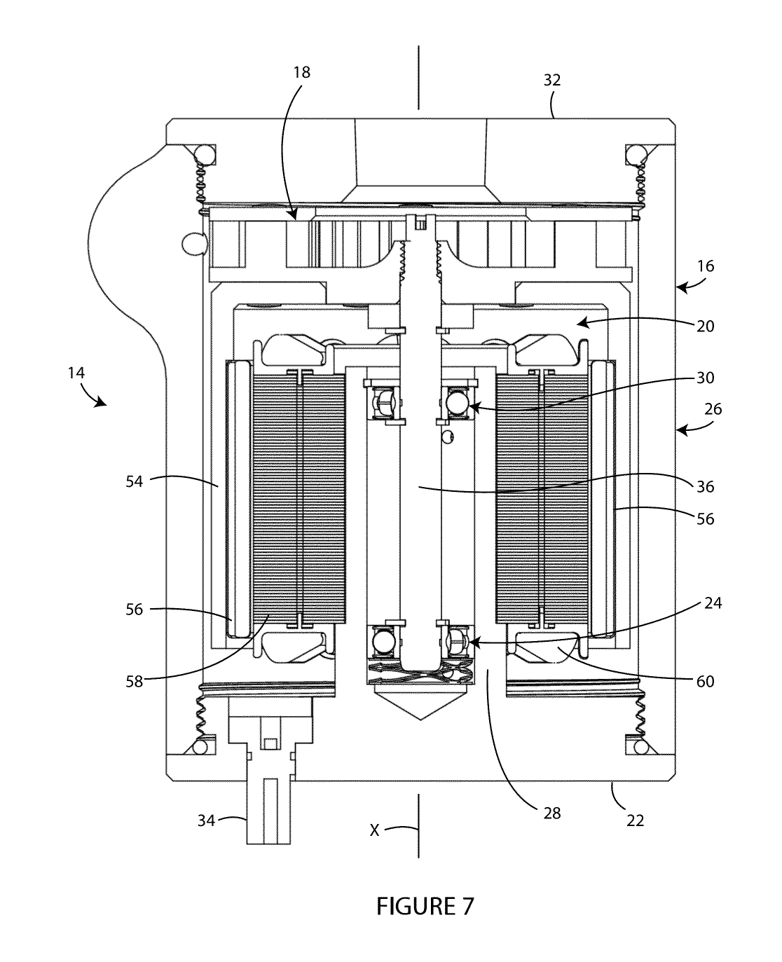

The turbine 18 includes a center shaft 36 mounted for rotation in the two bearing assemblies 24, 30. As shown in FIGS. 7 and 9, a turbine wheel 48 is mounted on the top of the turbine shaft 36 for rotation with the shaft. The turbine 18 is preferably a single-stage turbine that is comprised of a row of blades 50 that project upwardly from the turbine wheel 48 with each of the turbine blades being radially spaced from the turbine axis as shown in FIGS. 7 and 9. The turbine blades 50 are secured to and rotate with the turbine wheel 48. Refrigerant entering the housing 16 through the nozzle 40 passes through the blades 50 on the turbine wheel 48 before exiting the housing 16 through the outlet opening 34. The bottom surface of the turbine wheel 48 opposite the turbine blades 50 has a cylindrical wall 54 attached thereto. The cylindrical wall 54 is the rotor backing that supports permanent magnets 56 as shown in FIG. 7. The cylindrical wall 54 and ten permanent magnets 56 form the outside rotor of the generator 20. The generator 20 is preferably a ten pole generator comprised of a stack of stator plates 58 and six stator windings 60. The stack of stator plates 58 is secured stationary on the center column 28 of the center housing part 22. It is to be understood that other types of generators may be employed with the nozzle turbine system without departing from the scope of this invention.

Referring to FIG. 9, the passageway 62 preferably has a generally constant cross-sectional area along the passageway length P_{L}. For refrigeration systems using R410 refrigerant and having a capacity of five tons (60,000 btu/hr) of cooling capacity or less, the cross-sectional area of the passageway 62 is preferably between about 0.0023 in²/(ton of cooling capacity) (1.48 mm²/(ton of cooling capacity)) and about 0.0031 in²/(ton of cooling capacity) (2.00 mm²/(ton of cooling capacity)) and the cross-sectional area of the intake opening 38 is about 0.022 in²/(ton of cooling capacity) (14.2 mm²/(ton of cooling capacity)) 0.11 in² (71 mm²). Thus, for a five ton refrigeration system using R410 refrigerant, the cross-sectional area of the tube portion 42b is between about 0.012 in² (7.4 mm²) and about 0.016 in² (10 mm²) and the cross-sectional area of the intake opening 38 is about 0.11 in² (71 mm²). Also, the cross-sectional area of the tube portion 42b is preferably substantially the same as the cross-sectional area of the necked-down region 42a. The refrigerant is expanded in the nozzle 42 and the vapor content of the refrigerant increases as the refrigerant passes through the nozzle. The expansion of the refrigerant increases the velocity of the refrigerant. Preferably, the nozzle 42 is shaped and configured such that refrigerant entering the nozzle at X % liquid and (100-X) % vapor, by mass, is expanded as it passes through the nozzle and is discharged from the discharge end 68 of the passageway 62 in a liquid-vapor state with a liquid component that is at most at (X-5) % and a vapor component liquid that is at least (105-X) %, by mass. One of ordinary skill in the art will appreciate that “X”, as used herein, is typically the number 100, but could be a number somewhat less than 100. As a first example, the nozzle 42 is shaped and configured such that refrigerant entering the nozzle at 100% liquid (and 0% vapor) by mass, is expanded as it passes through the nozzle and is discharged from the discharge end 68 of the passageway 62 in a liquid-vapor state that is at most 90% liquid, by mass (and at least 10% vapor, by mass). As a second example, the nozzle 42 is shaped and configured such that refrigerant entering the nozzle at 98% liquid (and 2% vapor) by mass, is expanded as it passes through the nozzle and is discharged from the discharge end 68 of the passageway 62 in a liquid-vapor state that is at most 88% liquid, by mass (and at least 12% vapor, by mass). More preferably, the nozzle 42 is adapted and configured such that refrigerant entering the nozzle at X % liquid and (100-X) % vapor, by mass, is expanded as it passes through the nozzle and is discharged from the discharge end 68 of the passageway 62 in a liquid-vapor state that is at least at (X-20) % liquid and at most (120-X) % vapor, by mass. The nozzle 42 is adapted and configured such that the liquid component of the refrigerant discharged from the discharge end 68 of the passageway 62 preferably has a velocity that is at least 60% of the velocity of the vapor component of the refrigerant discharged from the discharge end 68 of the passageway 62, and more preferably has a velocity that is at least 70% of the velocity of the vapor component discharged from the discharge end 68 of the passageway 62. If the refrigerant is expanded too rapidly in the nozzle 42 (e.g., if the passageway 62 is insufficiently long), then the velocity of the liquid component will be insufficient to impart the desired force on the turbine blades 50. Preferably, the nozzle 42 is configured such that the liquid component of the refrigerant is discharged from the discharge end 68 of the passageway 62 at a velocity of at least about 190 feet per second (58 m/s), and more preferably at a velocity of at least about 220 feet per second (67 m/s).

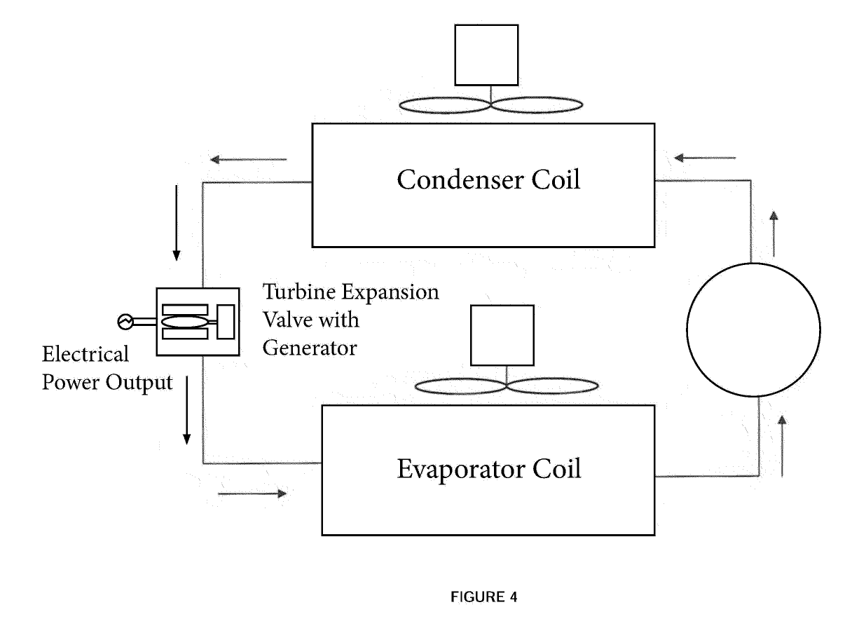

In operation of the energy recovery apparatus 14 of the invention in a refrigerant system (e.g., an air conditioning system) such as that shown in FIG. 4, entry of refrigerant into the housing 16 through the nozzle 40 results in a clockwise rotation of the turbine wheel 48 (as viewed in FIG. 9) relative to the housing. The refrigerant passes through the energy recovery apparatus 14 and exits through the housing outlet opening 34.

The refrigerant passing through the energy recovery apparatus 14 causes rotation of the turbine wheel 48 and the turbine shaft 46, which also causes rotation of the permanent magnets 56 on the cylindrical wall 54 of the rotor of the generator 20. The rotation of the permanent magnets 56 induces a current in the stator windings 60 which produces electricity from the energy recovery apparatus 14. The electricity produced can be routed back to a fan of the air conditioning system to help power its needs. This increases the energy efficiency of the air conditioning system and increases the SEER rating and the EER rating of the air conditioning system. The energy recovery apparatus 14 also increases the capacity of the evaporator by increasing the liquid percentage of the refrigerant entering the evaporator. It is also to be understood that the generator could be omitted. In a system without the generator, the turbine could be used to turn a fan or otherwise power (e.g., mechanically power) some component of the air conditioning system.

Referring again to FIG. 9, the nozzle 42 is configured to expand refrigerant discharged from the condenser and increase velocity of the refrigerant as it passes through the nozzle. Preferably, the housing 16, the turbine 18 and the generator 20 are arranged and configured such that refrigerant introduced into the housing cools and lubricates the generator. The housing 16 is configured such that, during normal operation of the energy recovery apparatus 14, refrigerant passing through the energy recovery apparatus escapes from the housing 16 only via the discharge port 34. The turbine and generator are in fluid communication with each other such that at least some refrigerant directed to the turbine is able to flow to the generator. The internal generator also eliminates any external shafts that would have to be refrigerant sealed. In other words, the housing 116 is preferably devoid of any openings for the passage of external shafts. As shown in FIG. 9, the housing 16 includes O-rings for preventing refrigerant leakage between the sidewall part 16 and the center housing part 22 and cover part 32. Alternatively, the housing parts may be sealed by any suitable means, e.g., by welding, for preventing refrigerant leakage between housing parts.

In operation, the intake port 38 of the energy recovery apparatus 14 is operatively coupled (e.g., via a refrigerant line) in fluid communication to the discharge port of a condenser of a refrigerant system such that refrigerant discharged from the condenser flows into the energy recovery apparatus. Similarly, the discharge port 34 of the energy recovery apparatus 14 is operatively coupled in fluid communication to the intake port of an evaporator such that refrigerant discharged from the energy recovery apparatus flows into the evaporator. Preferably, the refrigerant system is then operated such that refrigerant is discharged from the condenser in a liquid state at a temperature below (e.g., ten degrees F. below) the liquid saturation temperature for that same pressure. The refrigerant preferably enters the energy recovery apparatus 14 in a liquid state and is passed through the nozzle 42. The nozzle 42 is shaped and configured such that refrigerant entering the nozzle in a liquid state, is expanded by the nozzle, and is then discharged from the discharge end 68 of the passageway 62 in a liquid-vapor state. As such, passing the refrigerant through the nozzle 42 causes the refrigerant to decrease in pressure and temperature and expand from a liquid state to a liquid-vapor state. The refrigerant is discharged from the nozzle 42 at a low temperature, high velocity liquid-vapor and toward the blades 50 of the turbine 18. The refrigerant impacting the turbine blades causes the turbine to rotate about the turbine axis X, which also causes rotation of the permanent magnets on the cylindrical wall which form the rotor of the generator 20. The rotation of the permanent magnets induces a current in the stator windings of the generator to thereby produce electricity. The refrigerant then flows through the turbine 18 and is discharged out the discharge port 34 of the energy recovery apparatus 114 and conveyed to the evaporator. Preferably, the energy recovery apparatus 14 is configured to match the condenser and evaporator such that the refrigerant passing from the condenser through the energy recovery apparatus enters the evaporator at a pressure and temperature desirable for the evaporator. When operated in a in typical R410A five ton system, the energy recovery apparatus 14 should generate about 100 watts of electrical power at 80° F. ambient indoor temperate and 82° F. outdoor temperature, and about 125 watts at 95° F. outdoor temperature. In other words, the energy recovery apparatus 14 recovers about ⅓ of the available expansion energy.

The energy recovery apparatus of the present invention may be sold or distributed as part of a complete refrigerant system or as a separate unit to be added to a refrigerant system (e.g., to replace an expansion valve of an existing refrigeration system). In connection with the sale or distribution of the energy recovery apparatus, a user (e.g., a purchaser of the energy recovery apparatus) is instructed that the purpose of the energy recovery apparatus is to expand refrigerant in a refrigerant system. The user is induced to have the energy recovery apparatus placed in fluid communication with a condenser and evaporator of a refrigeration system.

A second embodiment of an energy recovery apparatus of the present invention is indicated generally by reference numeral 114 in FIG. 10. The energy recovery apparatus 114 is basically comprised of a housing 116, a turbine 118 and a generator (not shown). The energy recovery apparatus 114 is similar to the energy recovery apparatus 14 of FIGS. 5-9 except for the differences noted herein. In particular, the tube portion 142 converges from the necked-down region 142a to the downstream end of the tube. Thus, in this embodiment, at least a portion of the passageway converges as it extends toward the discharge end of the passageway.

As various modifications could be made in the constructions and methods herein described and illustrated without departing from the scope of the invention, it is intended that all matter contained in the foregoing description or shown in the accompanying drawings shall be interpreted as illustrative rather than limiting. For example, although the energy recovery apparatus 14 is shown as having only one nozzle, it is to be understood that an energy recovery apparatus in accordance of the present invention may have one, two or more nozzles. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

What is claimed is:

1. An energy recovery apparatus for use in a refrigeration system, the refrigeration system comprising an evaporator, a compressor and a condenser, the refrigeration system being configured to circulate refrigerant along a flow path such that the refrigerant flows from the evaporator to the compressor, and from the compressor to the condenser, and from the condenser to the evaporator, the energy recovery apparatus being adapted and configured to be in the flow path operatively between the condenser and the evaporator, the energy recovery apparatus comprising:
an intake port adapted to receive refrigerant and permit the refrigerant to flow into the energy recovery apparatus;
a discharge port adapted to permit refrigerant to flow out of the energy recovery apparatus;
a nozzle comprising a conduit region downstream of the intake port, the conduit region defining a passageway, the passageway being adapted to constitute a portion of the flow path, the passageway having an upstream cross-section, a downstream cross-section, a passageway length extending from the upstream cross-section to the downstream cross-section, and a discharge end, the downstream cross-section of the passageway being closer to the discharge end of the passageway than to the upstream cross-section, the cross-sectional area of the passageway at the downstream cross-section being not greater than the cross-sectional area of the passageway at any point along the passageway length, the passageway at the downstream cross-section having an effective diameter, the effective diameter being defined as (4A/π)^{1/2}, where A is the cross-sectional area of the passageway at the downstream cross-section, the passageway length being at least five times the effective diameter, the nozzle being adapted and configured such that refrigerant entering the nozzle at X % liquid and (100-X) % vapor, by mass, is expanded as it passes through the nozzle and is discharged from the discharge end of the passageway in a liquid-vapor state with a liquid component and a vapor component;
a turbine positioned and configured to be driven by refrigerant discharged from the discharge end of the passageway, the discharge port of the energy recovery apparatus being downstream of the turbine; and
a housing, the turbine being within the housing.

2. An energy recovery apparatus as set forth in claim 1 wherein the conduit region is integrally formed as a portion of the housing.

3. An energy recovery apparatus as set forth in claim 1 wherein the discharge end of the passageway is adjacent the downstream cross-section of the passageway.

4. An energy recovery apparatus as set forth in claim 1 further comprising a generator coupled to the turbine and adapted to be driven by the turbine, the generator being configured to produce electricity as a result of the turbine being driven by refrigerant discharged from the discharge end of the passageway.

5. An energy recovery apparatus as set forth in claim 4 wherein the generator is within the housing, and wherein the housing, the turbine, and the generator are arranged and configured such that refrigerant passing through the energy recovery apparatus cools and lubricates the generator.

6. An energy recovery apparatus as set forth in claim 4 wherein the passageway length is at least seven and one-half times the effective diameter.

7. An energy recovery apparatus as set forth in claim 4 wherein the passageway length is at least ten times the effective diameter.

8. An energy recovery apparatus as set forth in claim 4 wherein the passageway length is at least twelve times the effective diameter.

9. An energy recovery apparatus as set forth in claim 1 wherein the intake and discharge ports constitute portions of the housing, and wherein the housing is configured such that during normal operation of the energy recovery apparatus, refrigerant passing through the energy recovery apparatus escapes from the housing only via the discharge port.

10. An energy recovery apparatus as set forth in claim 1 wherein the passageway length is at least seven and one-half times the effective diameter.

11. An energy recovery apparatus as set forth in claim 1 wherein the passageway length is at least ten times the effective diameter.

12. An energy recovery apparatus as set forth in claim 1 wherein the passageway length is at least twelve times the effective diameter.

13. An energy recovery apparatus as set forth in claim 1 wherein the nozzle is adapted and configured such that the liquid component of the refrigerant discharged from the discharge end of the passageway has a velocity that is at least 60% that of the vapor component of the refrigerant discharged from the discharge end of the passageway.

14. An energy recovery apparatus as set forth in claim 1 wherein the nozzle is adapted and configured to discharge the liquid component of the refrigerant from the discharge end of the passageway at a velocity of at least about 190 feet per second (58 m/s).

15. An energy recovery apparatus as set forth in claim 1 wherein the passageway has a generally constant cross-sectional area along the passageway length.

16. An energy recovery apparatus as set forth in claim 1 wherein the nozzle further comprises a necked down-region, the passageway being downstream of the necked-down region, the necked-down region being adapted to constitute a portion of the flow path.

17. An energy recovery apparatus as set forth in claim 1 wherein at least a portion of the passageway converges as it extends toward the discharge end of the passageway.

18. A method comprising modifying a refrigeration system, the refrigeration system comprising an evaporator, a compressor, condenser, and an expansion valve, the refrigeration system being configured to circulate refrigerant along a flow path such that the refrigerant flows from the evaporator to the compressor, and from the compressor to the condenser, and from the condenser to the expansion valve, and from the expansion valve to the evaporator, the method comprising:
replacing the expansion valve with an energy recovery apparatus as set forth in claim 1 such that the passageway of the conduit region of the nozzle constitutes a portion of the flow path.

19. A refrigeration system comprising an evaporator, a compressor, a condenser, and an energy recovery apparatus as set forth in claim 1, the refrigeration system being configured to circulate refrigerant along a flow path such that the refrigerant flows from the evaporator to the compressor, and from the compressor to the condenser, and from the condenser to the energy recovery apparatus, and from the energy recovery apparatus to the evaporator.

20. An energy recovery apparatus for use in a refrigeration system, the refrigeration system comprising an evaporator, a compressor and a condenser, the refrigeration system being configured to circulate refrigerant along a flow path such that the refrigerant flows from the evaporator to the compressor, and from the compressor to the condenser, and from the condenser to the evaporator, the energy recovery apparatus being adapted and configured to be in the flow path operatively between the condenser and the evaporator, the energy recovery apparatus comprising:
an intake port adapted to receive refrigerant and permit the refrigerant to flow into the energy recovery apparatus;
a discharge port adapted to permit refrigerant to flow out of the energy recovery apparatus;
a nozzle comprising a conduit region downstream of the intake port, the conduit region defining a passageway, the passageway being adapted to constitute a portion of the flow path, the passageway having an upstream cross-section, a downstream cross-section, a passageway length extending from the upstream cross-section to the downstream cross-section, and a discharge end, the discharge end of the passageway coinciding with the downstream cross-section of the passageway, the cross-sectional area of the passageway at the downstream cross-section being not greater than the cross-sectional area of the passageway at any point along the passageway length, the nozzle being adapted and configured such that refrigerant entering the nozzle at X % liquid and (100-X) % vapor, by mass, is expanded as it passes through the nozzle and is discharged from the discharge end of the passageway in a liquid-vapor state with a liquid component and a vapor component, the nozzle being adapted and configured to discharge the liquid component of the refrigerant from the discharge end of the passageway at a velocity of at least about 190 feet per second (58 m/s);
a turbine positioned and configured to be driven by refrigerant discharged from the discharge end of the passageway, the discharge port of the energy recovery apparatus being downstream of the turbine; and
a housing, the turbine being within the housing.

21. An energy recovery apparatus as set forth in claim 20 wherein the nozzle is adapted and configured to discharge the liquid component of the refrigerant from the discharge end of the passageway at a velocity of at least about 220 feet per second (67 m/s).

22. An energy recovery apparatus for use in a refrigeration system, the refrigeration system comprising an evaporator, a compressor and a condenser, the refrigeration system being configured to circulate refrigerant along a flow path such that the refrigerant flows from the evaporator to the compressor, and from the compressor to the condenser, and from the condenser to the evaporator, the energy recovery apparatus being adapted and configured to be in the flow path operatively between the condenser and the evaporator, the energy recovery apparatus comprising:
an intake port adapted to receive refrigerant and permit the refrigerant to flow into the energy recovery apparatus;
a discharge port adapted to permit refrigerant to flow out of the energy recovery apparatus;
a nozzle comprising a conduit region downstream of the intake port, the conduit region defining a passageway, the passageway being adapted to constitute a portion of the flow path, the passageway having an upstream cross-section, a downstream cross-section, a passageway length extending from the upstream cross-section to the downstream cross-section, and a discharge end, the discharge end of the passageway coinciding with the downstream cross-section of the passageway, the cross-sectional area of the passageway at the downstream cross-section being not greater than the cross-sectional area of the passageway at any point along the passageway length, the nozzle being adapted and configured such that refrigerant entering the nozzle at X % liquid and (100-X) % vapor, by mass, is expanded as it passes through the nozzle and is discharged from the discharge end of the passageway in a liquid-vapor state with a liquid component and a vapor component, the nozzle being adapted and configured such that the liquid component of the refrigerant discharged from the discharge end of the passageway has a velocity that is at least 60% that of the vapor component of the refrigerant discharged from the discharge end of the passageway;
a turbine positioned and configured to be driven by refrigerant discharged from the discharge end of the passageway, the discharge port of the energy recovery apparatus being downstream of the turbine.

23. An energy recovery apparatus as set forth in claim 22 further comprising a generator coupled to the turbine and adapted to be driven by the turbine, the generator being configured to produce electricity as a result of the turbine being driven by refrigerant discharged from the discharge end of the passageway.

24. An energy recovery apparatus as set forth in claim 23 further comprising a housing, the turbine and the generator being within the housing.

25. An energy recovery apparatus as set forth in claim 24 wherein the intake and discharge ports constitute portions of the housing, and wherein the housing is configured such that during normal operation of the energy recovery apparatus, refrigerant passing through the energy recovery apparatus escapes from the housing only via the discharge port.

26. An energy recovery apparatus as set forth in claim 22 wherein X equals 100.

27. An energy recovery apparatus as set forth in claim 22 wherein the nozzle is adapted and configured such that the liquid component of the refrigerant discharged from the discharge end of the passageway has a velocity that is at least 70% that of the vapor component of the refrigerant discharged from the discharge end of the passageway.

28. An energy recovery apparatus as set forth in claim 22 wherein the nozzle is adapted and configured to discharge the liquid component of the refrigerant from the discharge end of the passageway at a velocity of at least about 220 feet per second (67 m/s).

29. An energy recovery apparatus as set forth in claim 22 wherein the passageway at the downstream cross-section has an effective diameter, the effective diameter being defined as (4A/π)^{1/2}, where A is the cross-sectional area of the passageway at the downstream cross-section, the passageway length being at least five times the effective diameter.

30. An energy recovery apparatus as set forth in claim 29 wherein the passageway length is at least seven and one-half times the effective diameter.

31. An energy recovery apparatus as set forth in claim 29 wherein the passageway length is at least ten times the effective diameter.

32. An energy recovery apparatus as set forth in claim 29 wherein the passageway length is at least twelve times the effective diameter.

33. A method comprising operatively coupling the discharge port of an energy recovery apparatus as set forth in claim 22 to an evaporator of a refrigeration system such that the discharge port of the energy recovery apparatus is in fluid communication with the evaporator.

34. A method comprising instructing a user to place an energy recovery apparatus as set forth in claim 22 in fluid communication with an evaporator of a refrigeration system.

35. A method comprising selling an energy recovery apparatus as set forth in claim 22 and including with the energy recovery apparatus indicia that the energy recovery apparatus is to be placed in fluid communication with an evaporator of a refrigeration system.

36. A method comprising inducing a user to place an energy recovery apparatus as set forth in claim 22 in fluid communication with a refrigeration line of a refrigeration system.
